(19) United States
(12) Patent Application Publication
(10) Pub. No.: US 2026/0117858 A1
(43) Pub. Date: Apr. 30, 2026

(54) SYNCHRONIZATION SYSTEM AND METHOD OF SENSORS OF ELECTRIC SHIFT LEVER SYSTEM FOR VEHICLE

(71) Applicant: Hyundai Kefico Corporation, Gunpo (KR)

(72) Inventor: Ji Hyeok Kang, Gunpo, (KR)

(21) Appl. No.: 19/371,889

(22) Filed: Oct. 28, 2025

(30) Foreign Application Priority Data
Oct. 29, 2024 (KR) 10-2024-0150202

(51) Int. Cl. F16H 59/10; F16H 59/02; F16H 61/12; F16H 61/32; F16H 63/30; G01D 5/14; G07C 5/08

(52) U.S. Cl. CPC F16H 59/105; F16H 59/0217; F16H 61/12; F16H 61/32; F16H 63/304; G01D 5/142; G07C 5/0808; F16H 2061/1212; F16H 2061/1284; F16H 2061/326

(57) ABSTRACT

A synchronization system and method incorporate an absolute location sensor such as a position sensor and a relative location sensor such as hall sensor of an electric shift lever system. The synchronization system includes a shift lever sensor configured to detect a manipulation signal of a shift lever when a vehicle driving mode is shifted, an electric motor configured to switch a gear shift stage according to manipulation of the shift lever, the hall sensor attached to the electric motor and configured to detect a rotated relative angle, the position sensor configured to detect an absolute location of the electric motor, and a controller configured to receive signals generated from the shift lever sensor, the hall sensor, and the position sensor, and control the electric motor so that the gear shift stage according to manipulation of the shift lever is switched based on the received signals.

### CROSS REFERENCE TO RELATED APPLICATION

The present application claims under 35 U.S.C. § 119 (a) the benefit of Korean Patent Application No. 10-2024-0150202, filed Oct. 29, 2024, the entire contents of which are incorporated by reference herein.

### BACKGROUND

### (a) Technical Field

The present disclosure relates to a synchronization system and method of sensors of an electric shift lever system for a vehicle, more particularly, to synchronizing a relative location sensor, such as a hall sensor, with an absolute location sensor, such as a position sensor, so that a synchronization signal value calculated from the relative location sensor is provided to a gear shift controller when failure of the absolute location sensor occurs.

### (b) Description of the Related Art

Unlike a mechanical shift lever system using a mechanical link structure such as a wire, an electric shift lever system performs gear shifting using an electrical signal. Specifically, the electric shift lever system is a system that receives an electrical signal corresponding to a driver's manipulation of a shift lever and determines a state of a vehicle which the driver wants and switches a gear shift stage by rotating an electric motor. Such a system causes almost no gear shift shock or vibration, and unlike the mechanical shift lever system, simplifies a coupling means between a lever device and a transmission, thereby preventing gear shifting due to unintended movement of the lever. Accordingly, vehicles adopting such a system have increased in number.

In such an electric shift lever system, a shift control unit (SCU) or a SBW control unit serves as a brain of the system, and is a controller that converts a gear shift command, given by a driver through a button or an electronic shift lever, into an electrical signal to control the transmission.

In addition, in order to perform stable gear shift control, it is important to recognize and control the location of the motor. The electric motor used in the electric shift lever system is driven through feedback control, and sensors used for feedback control include a position sensor for detecting a rotation amount of a motor output shaft and a hall sensor for detecting the rotation amount of a motor rotor.

Regarding the characteristics of each sensor, the position sensor has characteristics of an absolute location sensor and detects a rotation amount of a motor output shaft, and thus can detect an actual location of the motor more accurately and is used to determine a current location of the motor.

In addition, the hall sensor has characteristics of a relative location sensor and measures a rotation angle by counting moments when a hall element is passed, and transmits a relative location of a motor rotor, thereby allowing a controller to drive the motor with three-phase currents (U, V, and W) in a direction corresponding to a control command.

In the electric shift lever system, since the sensors are important, it is required to realize a fail-safe function for sensor failure situations.

However, in the related art, when a failure of a position sensor occurs, there is no means for replacing the position sensor. Therefore, when a failure of a position sensor of an electric shift lever system occurs while driving, the system can only notify the driver of the component failure and request the driver to stop the vehicle. In this case, a failure of the sensor, which is merely a single component, may lead to a situation in which all functions of the vehicle are restricted.

Accordingly, there is a need for a technology capable of performing a back-up function at the same level as when the position sensor is normal, even when a failure of the position sensor occurs.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure is directed to providing a synchronized backup signal when a failure of an absolute location sensor (e.g., position sensor) occurs by synchronizing a relative location sensor (e.g., a hall sensor) in an electric shift lever system with the absolute location sensor.

In order to achieve the above objective, according to the present disclosure, when the position sensor is normal during driving of a controller, the position sensor value at that time point is set as an initial value of the hall sensor, which is a relative location sensor, and a hall sensor variation is cumulatively applied to the initial value, thereby generating a signal synchronized with the position sensor. In addition, a synchronization signal value is a signal updated based on a rotation amount of a motor rotor and a position sensor value is a signal updated based on a rotation amount of a motor output shaft, so a difference between the synchronization signal value and the position sensor value may increase. Therefore, by performing a monitoring function, synchronization is performed again when the difference is large.

According to the present disclosure, a synchronization system of an electric shift lever system of a vehicle includes: a shift lever sensor configured to detect a manipulation signal of a shift lever; an electric motor configured to switch a gear shift stage according to manipulation of the shift lever; a relative location sensor attached to the electric motor and configured to detect a rotated relative angle; an absolute location sensor configured to detect an absolute location of the electric motor; and a controller configured to receive signals generated from the shift lever sensor, the relative location sensor, and the absolute location sensor, and control the electric motor so that the gear shift stage according to manipulation of the shift lever is switched based on the received signals, wherein the controller is configured to synchronize the absolute location sensor with the relative location sensor.

In addition, the controller may be configured to monitor a synchronization state, and perform gear shift control by using a synchronization signal value of the relative location sensor when a failure of the absolute location sensor occurs.

For example, the relative location sensor may be a hall sensor.

For example, the absolute location sensor may be a position sensor.

In addition, the shift lever sensor may detect the manipulation signal when a vehicle driving mode is shifted.

Further, the vehicle driving mode may be configured to be shifted by a driver of the vehicle.

According to another aspect of the present disclosure, there is provided a synchronization system of a position sensor and a hall sensor of an electric shift lever system, the synchronization system including: a shift lever sensor configured to detect a manipulation signal of a shift lever when a vehicle driving mode is shifted; an electric motor configured to switch a gear shift stage according to manipulation of the shift lever; the hall sensor attached to the electric motor and configured to detect a rotated relative angle; the position sensor configured to detect an absolute location of the electric motor; and a controller configured to receive signals generated from the shift lever sensor, the hall sensor, and the position sensor, and control the electric motor so that the gear shift stage according to manipulation of the shift lever is switched based on the received signals, wherein the controller is configured to synchronize the position sensor with the hall sensor, monitor a synchronization state, and perform gear shift control by using a synchronization signal value of the hall sensor when a failure of the position sensor occurs.

Herein, the controller may include a motor driving determination part, a synchronization sequence controller, and a sensor failure diagnosis part, the synchronization sequence controller may include a synchronization condition determination part, a synchronization performing part, a synchronization state monitoring part, and a synchronization signal value use permission part, and the sensor failure diagnosis part may include a position sensor failure diagnosis part and a hall sensor failure diagnosis part.

In addition, the synchronization condition determination part may be configured to receive information on whether the position sensor and the hall sensor are normal and on a motor driving state from the sensor failure diagnosis part and the motor driving determination part, and determine whether a condition for generating the synchronization signal value is satisfied, the synchronization performing part may be configured to set, as an initial value, a position sensor value at a time point at which the synchronization signal value is able to be generated, and generate the synchronization signal value by cumulatively applying a hall sensor variation to the initial value, the synchronization state monitoring part may be configured to continuously monitor whether the position sensor value and the synchronization signal value are synchronized, and the synchronization signal value use permission part may be configured to, when it is determined that the synchronization state is normal and the failure of the position sensor occurs, permit use of the synchronization signal value.

In addition, the synchronization sequence controller may further include a synchronization failure diagnosis part and a synchronization reattempt part.

In addition, the synchronization failure diagnosis part may be configured to determine a synchronization error when synchronization monitoring abnormality is detected, and the synchronization reattempt part may be configured to determine whether synchronization reattempt is possible and count up the number of reattempts.

In addition, the position sensor failure diagnosis part may be configured to diagnose a short to ground when a position sensor value is 0%, diagnose a short to battery when the position sensor value is 100%, diagnose an out of range when a value outside a preset normal range is shown, or diagnose a jump error when a change in a value within a diagnosis execution period is detected to be abnormal.

In addition, the hall sensor failure diagnosis part may be configured to determine whether a failure occurs based on a hall pattern generated by a plurality of hall sensors. A hall pattern is shown in a predetermined order according to clockwise or counterclockwise rotation. The hall sensor failure diagnosis part may be configured to determine an invalid pattern error and diagnose a failure of the hall sensor when the predetermined order is violated or an invalid pattern is detected.

A vehicle may incorporate the above-described synchronization system.

According to the present disclosure, a synchronization method of an electric shift lever system may include: a synchronization condition determination step of determining whether a condition for synchronization is satisfied, based on information on whether the absolute location sensor and the relative location sensor are normal and a motor driving state; a synchronization performing step of setting, as an initial value, an absolute location sensor value at a time point at which synchronization is able to be performed, and generating a synchronization signal value by cumulatively applying a relative location sensor variation to the initial value; a synchronization state monitoring step of monitoring whether the absolute location sensor value and the synchronization signal value are synchronized; and a synchronization signal value use permission step of permitting use of the synchronization signal value when a synchronization state is normal in the synchronization state monitoring step and a failure of the absolute location sensor is detected. According to a further aspect of the present disclosure, there is provided a synchronization method of a position sensor and a hall sensor of an electric shift lever system, the synchronization method including: a synchronization condition determination step of determining whether a condition for synchronization is satisfied, based on information on whether the position sensor and the hall sensor are normal and a motor driving state; a synchronization performing step of setting, as an initial value, a position sensor value at a time point at which synchronization is able to be performed, and generating a synchronization signal value by cumulatively applying a hall sensor variation to the initial value; a synchronization state monitoring step of monitoring whether the position sensor value and the synchronization signal value are synchronized; and a synchronization signal value use permission step of permitting use of the synchronization signal value when a synchronization state is normal in the synchronization state monitoring step and a failure of the position sensor is detected.

In addition, in the synchronization state monitoring step, when an absolute value of a value obtained by subtracting a variation of the synchronization signal value from a variation of the position sensor value at a monitoring time point is higher than a particular value and is maintained for a predetermined time, it may be determined that the synchronization state is abnormal.

In addition, when the synchronization state is abnormal in the synchronization state monitoring step, the synchronization method may further include a synchronization failure diagnosis step and a synchronization reattempt step.

In addition, in the synchronization failure diagnosis step and the synchronization reattempt step, it may be determined whether the failure of the position sensor occurs, and when the failure of the position sensor has not occurred, synchronization may be reattempted, and when synchronization reattempt is performed a predetermined number of times or more, a synchronization failure may be diagnosed.

According to the synchronization system and the synchronization method of the position sensor and the hall sensor of the electric shift lever system according to the present disclosure, even when a failure of the position sensor occurs, the hall sensor provides a signal synchronized with the position sensor through a fail-safe function. Therefore, the vehicle can be operated in the same manner as when the position sensor is normal, and robustness against a failure of the position sensor can be achieved.

In addition, even when a failure of the position sensor occurs temporarily, the synchronization signal value can be immediately used, so that excessive vehicle failure signals and vehicle operation restriction are not required, thereby increasing the vehicle user's satisfaction.

According to the present disclosure, a non-transitory computer readable medium containing program instructions executed by a processor may include: program instructions that determine whether a condition for synchronization is satisfied, based on information on whether an absolute location sensor and a relative location sensor are normal and a motor driving state; program instructions that set, as an initial value, an absolute location sensor value at a time point at which synchronization is able to be performed, and generate a synchronization signal value by cumulatively applying a relative location sensor variation to the initial value; program instructions that monitor whether the absolute location sensor value and the synchronization signal value are synchronized; and program instructions that permit use of the synchronization signal value when a synchronization state is normal in the synchronization state monitoring step and a failure of the absolute location sensor is detected.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view of an electric shift lever system;

FIG. 2 is a diagram illustrating a connection relationship between elements related to a synchronization system according to an embodiment of the present disclosure;

FIG. 3 is a flowchart illustrating the overall flow of a synchronization method according to another embodiment of the present disclosure;

FIG. 4 is a flowchart illustrating the operation of a synchronization method according to another embodiment of the present disclosure; and

FIGS. 5A to 5C are graphs illustrating an example of performing a synchronization method according to another embodiment of the present disclosure.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, an exemplary embodiment of the present disclosure will be described in detail with reference to the drawings.

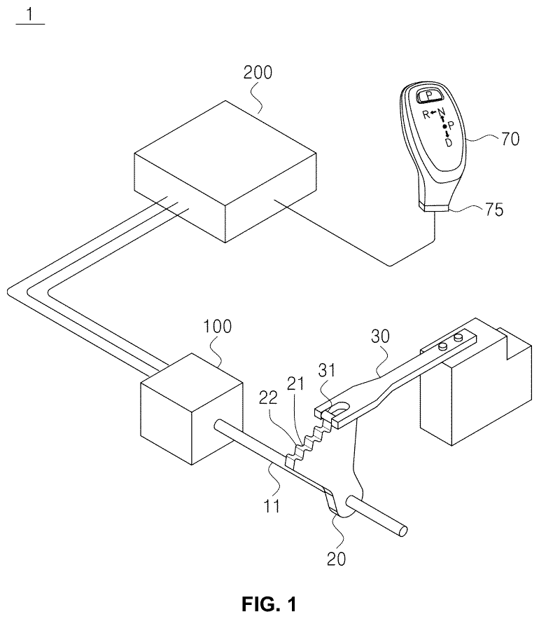

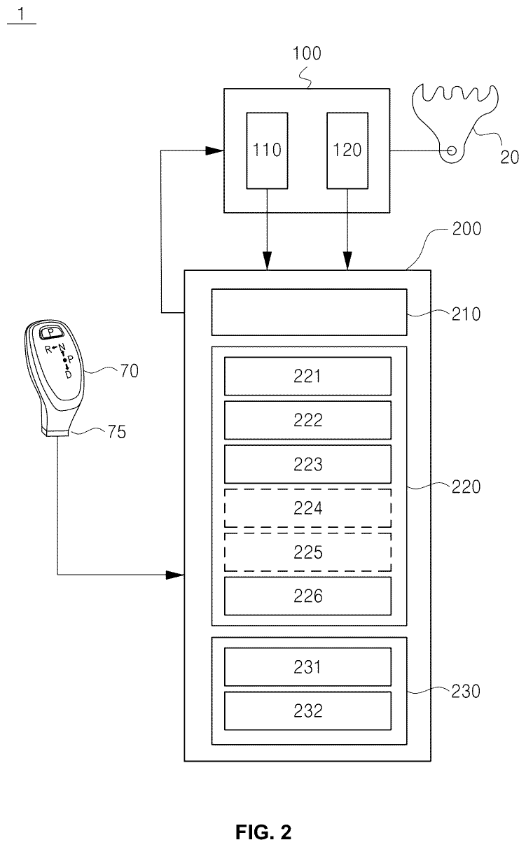

First, an electric shift lever system in the technical field to which the present disclosure belongs and a synchronization system of a position sensor and a hall sensor of an electric shift lever system according to the present disclosure will be described with reference to FIG. 1, which is a perspective view of an electric shift lever system, and FIG. 2, which shows a connection relationship between control-related elements.

Referring to FIG. 1, an electric shift lever system 1 includes a motor 100 configured to control a gear shift stage, and a detent plate 20 and a detent spring 30 configured to switch the gear shift stage according to driving of the motor 100.

When a driver manipulates a shift lever 70 to a particular location, an electrical signal of a gear shift stage sensor 75 corresponding to the manipulated location may be transmitted to a controller 200 and a gear shift stage switch signal of the controller 200 may be transmitted to the motor 100. The motor 100 may rotate in a forward direction or a reverse direction according to the received electrical signal.

The detent plate 20 may be connected to the motor 100 through a rotation shaft 11. Accordingly, rotation of the motor 100 may be transmitted to the detent plate 20, and when the motor 100 rotates, the detent plate 20 may also rotate.

As shown in FIG. 1, the detent plate 20 may have a grooves 21 and ridges 22. The grooves 21 may be locations at which a roller 31 of the detent spring 30 is deposited, and a particular gear shift stage may correspond to each groove 21. Accordingly, as the roller 31 moves from one groove to another, the gear shift stage may be switched.

According to an embodiment of the present disclosure, a synchronization system of a position sensor and a hall sensor of an electric shift lever system includes a shift lever sensor 75, an electric motor 100, a hall sensor 120, a position sensor 110, and a controller 200. The shift lever sensor 75 is configured to detect a manipulation signal of a shift lever 70 when a driver shifts a vehicle driving mode. The electric motor 100 is configured to switch a gear shift stage according to manipulation of the shift lever. The hall sensor 120 is attached to the electric motor and is configured to detect a rotated relative angle. The position sensor 110 is configured to detect an absolute location of the electric motor. The controller 200 is configured to receive signals generated from the shift lever sensor 75, the hall sensor 120, and the position sensor 110, and to control the electric motor so that the gear shift stage according to manipulation of the shift lever is switched based on the received signals.

The controller 200 synchronizes the position sensor 110 with the hall sensor 120, monitors a synchronization state, and performs gear shift control using a synchronization signal value of the hall sensor 120 when a failure of the position sensor 110 occurs.

Herein, the controller 200 includes a motor driving determination part 210, a synchronization sequence controller 220, and a sensor failure diagnosis part 230. The synchronization sequence controller 220 includes a synchronization condition determination part 221, a synchronization performing part 222, a synchronization state monitoring part 223, and a synchronization signal value use permission part 226. The sensor failure diagnosis part 230 may include a position sensor failure diagnosis part 231 and a hall sensor failure diagnosis part 232.

In addition, the synchronization condition determination part 221 receives information on whether the position sensor 110 and the hall sensor 120 are normal and on a motor driving state from the sensor failure diagnosis part 230 and the motor driving determination part 210, and determines whether a condition for generating a synchronization signal value is satisfied. The synchronization performing part 222 sets, as an initial value, a position sensor value at a time point at which a synchronization signal value is able to be generated, and generates a synchronization signal value by cumulatively applying a hall sensor variation to the initial value. The synchronization state monitoring part 223 continuously monitors whether the position sensor value and the synchronization signal value are synchronized. When it is determined that the synchronization state is normal and a failure of the position sensor occurs, the synchronization signal value use permission part 226 may permit use of the synchronization signal value.

In addition, the synchronization sequence controller 220 may further include a synchronization failure diagnosis part 224, and a synchronization reattempt part 225. Herein, the synchronization failure diagnosis part 224 may determine a synchronization error when synchronization monitoring abnormality is detected, and the synchronization reattempt part 225 may determine whether synchronization reattempt is possible and count up the number of reattempts.

In the meantime, the position sensor failure diagnosis part 231 may diagnose a short to ground (SG) when a position sensor value is 0%, may diagnose a short to battery (SB) when the position sensor value is 100%, may diagnose an out of range when a value outside a preset normal range is shown, or may diagnose a jump error when a change in the value within a diagnosis execution period is detected to be abnormal.

In addition, the hall sensor failure diagnosis part 232 determines whether a failure occurs based on a hall pattern generated by a plurality of hall sensors. A hall pattern is shown in a predetermined order according to clockwise or counterclockwise rotation. When the predetermined order is violated or an invalid pattern is detected, the hall sensor failure diagnosis part determines an invalid pattern error and diagnoses a failure of the hall sensor.

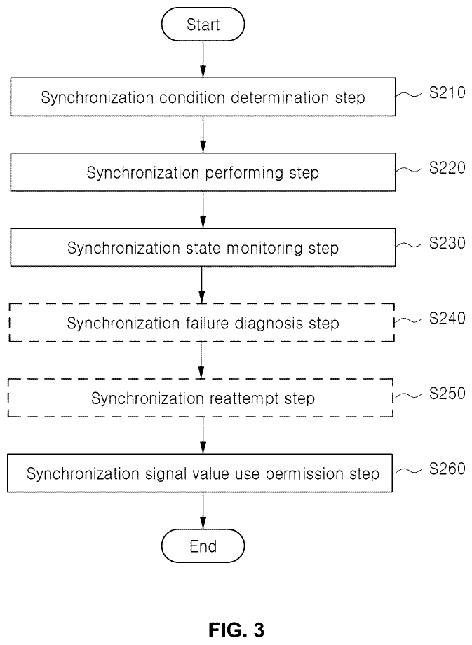

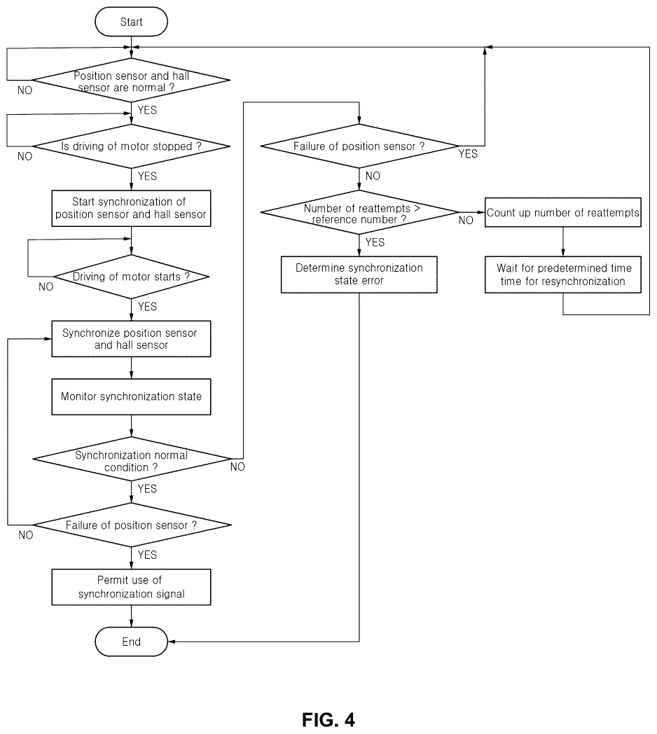

FIG. 3 is a flowchart illustrating the overall flow of a synchronization method of a position sensor and a hall sensor of an electric shift lever system according to an exemplary embodiment of the present disclosure. FIG. 4 is a detailed flowchart illustrating a synchronization method.

Referring to FIG. 3, as another embodiment of the present disclosure, a synchronization method of a position sensor and a hall sensor of an electric shift lever system may generally include a synchronization condition determination step S210, a synchronization performing step S220, a synchronization state monitoring step S230, and a synchronization signal value use permission step S260, and may further include a synchronization failure diagnosis step S240 and a synchronization reattempt step S250.

More specifically, the synchronization method of the position sensor and the hall sensor of the electric shift lever system according to the present disclosure may include: the synchronization condition determination step S210 of determining whether a condition for synchronization is satisfied, based on information on whether the position sensor and the hall sensor are normal and a motor driving state; the synchronization performing step S220 of setting, as an initial value, a position sensor value at a time point at which synchronization is able to be performed and generating a synchronization signal value by cumulatively applying a hall sensor variation to the initial value; the synchronization state monitoring step S230 of monitoring whether the position sensor value and the synchronization signal value are synchronized; and the synchronization signal value use permission step S260 of permitting use of the synchronization signal value when the synchronization state is normal in the synchronization state monitoring step and a failure of the position sensor is detected.

In addition, in the synchronization state monitoring step S230, when an absolute value of a value obtained by subtracting the synchronization signal value from the position sensor value at a monitoring time point is lower than a particular value and is maintained for a predetermined time, it may be determined that the synchronization state is normal.

In addition, the synchronization method of the position sensor and the hall sensor of the electric shift lever system according to the present disclosure may further include the synchronization failure diagnosis step S240 and the synchronization reattempt step S250 when the synchronization state is abnormal in the synchronization state monitoring step S230.

In addition, in the synchronization failure diagnosis step and the synchronization reattempt step, it is determined whether a failure of the position sensor occurs, and synchronization is reattempted when the failure of the position sensor has not occurred, and a synchronization failure may be diagnosed when the reattempt is performed a predetermined number of times or more.

Next, the sequence the synchronization method of the position sensor and the hall sensor of the electric shift lever system according to the above-described embodiment of the present disclosure will be sequentially described with reference to FIG. 4.

In the synchronization method of the present disclosure, first, in the synchronization condition determination step S210, a process of determining whether the position sensor 110 and the hall sensor 120 are normal is performed. Herein, when the position sensor 110 and the hall sensor 120 are not in a normal state, the synchronization method is not performed, and execution of the synchronization method of the present disclosure does not start until it is determined that the position sensor and the hall sensor are normal.

Next, when both the position sensor 110 and the hall sensor 120 are in the normal state, a process of determining whether the motor 100 is stopped is then performed. Herein, when the motor is being driven, execution of the synchronization method of the present disclosure does not start until the driving of the motor is stopped.

When it is determined that the motor 100 is stopped, a synchronization start process of the position sensor 110 and the hall sensor 120 is then performed as the synchronization performing step S220. The synchronization start process is performed by setting, as an initial value of the synchronization signal value, the position sensor value at the time point at which the synchronization signal value is able to be generated, that is, a time point at which it is determined that both the position sensor 110 and the hall sensor 120 are in the normal state in the process of determining whether the position sensor 110 and the hall sensor 120 are normal and it is then determined that the motor is stopped in the process of determining whether the motor 100 is stopped.

In addition, after the synchronization start process, it is determined whether driving of the motor is started. When driving of the motor is started, a synchronization process of the position sensor 110 and the hall sensor 120 is then performed, and a process of monitoring the synchronization state is then performed as the synchronization state monitoring step S230. Herein, the synchronization process of the position sensor 110 and the hall sensor 120 is performed as a process of updating the synchronization signal value by accumulating a hall sensor variation for each task to the synchronization signal value from the previous task.

Herein, the hall sensor variation may be a value obtained by subtracting a hall sensor value at the previous task or sequence from a hall sensor value at the current task or sequence.

In addition, monitoring of the synchronization state is performed because the position sensor value and the synchronization signal value may deviate due to unpredictable reasons.

The process of monitoring the synchronization state performed as the synchronization state monitoring step S230 may include a process of determining that the synchronization state is abnormal when the absolute value of the value obtained by subtracting the synchronization signal value from the position sensor value at the monitoring time point is higher than the particular value and is maintained for the predetermined time. When this condition is not satisfied, it may be determined that the synchronization state is normal.

In addition, when it is determined that the synchronization state is normal in the above process, a failure of the position sensor is then determined. When a failure of the position sensor occurs, a process of permitting the synchronization signal value at that time point to be used for gear shift control is performed as the synchronization use permission step. In addition, when a failure of the position sensor has not occurred, proceeding back to the step of synchronizing the position sensor value with the hall sensor value takes place and the next task is performed. Herein, the step of synchronizing the position sensor value with the hall sensor value is performed as a process of accumulating a variation of the hall sensor value to the synchronization signal value, as described above.

When it is determined that the synchronization state is abnormal, that is, when the absolute value of the value obtained by subtracting the synchronization signal value from the position sensor value at the monitoring time point is higher than the particular value, the synchronization failure diagnosis step and the synchronization reattempt step are then performed. In these steps, a process of determining whether a failure of the position sensor occurs is first performed. When it is determined that a failure of the position sensor has not occurred, a synchronization reattempt process is then performed a predetermined number of times. Each time reattempt is performed, a process of counting up the number of reattempts is performed. Next, as the synchronization condition determination step S210, proceeding back to the process of determining whether the position sensor 110 and the hall sensor 120 are normal takes place. Accordingly, a synchronization sequence according to the present disclosure is repeated. Herein, as shown in the flowchart, a predetermined waiting time may elapse before returning for resynchronization.

When the synchronization reattempt is performed a predetermined number of times or more, a synchronization failure is diagnosed and execution of the synchronization method according to the present disclosure is terminated.

In the execution process of the synchronization method, as described above with respect to the position sensor failure diagnosis part, the failure of the position sensor is determined as follows. When a position sensor value is 0%, a short to ground (SG) is diagnosed, or when the position sensor value is 100%, a short to battery (SB) is diagnosed, or when a value outside a preset normal range is shown, an out of range is diagnosed, or when a change in the value within a diagnosis execution period is detected to be abnormal, which is a jump error, the failure is determined. In addition, as described above with respect to the hall sensor failure diagnosis part, whether a failure of the hall sensor occurs is determined based on a hall pattern generated by a plurality of hall sensors. When a hall pattern is not shown in a predetermined order according to clockwise or counterclockwise rotation or an invalid pattern is detected, the pattern is determined to be invalid, and consequently, the failure of the hall sensor is diagnosed.

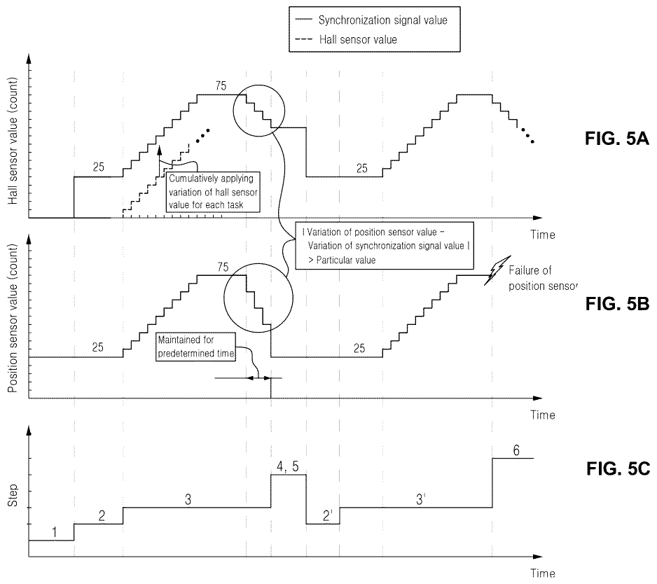

FIGS. 5A to 5C are graphs illustrating a process in which the synchronization method of the present disclosure is actually implemented according to the processes described above. FIG. 5A is a graph illustrating changes in the hall sensor value and the synchronization signal value over time, FIG. 5B is a graph illustrating changes in the position sensor value, and FIG. 5C is a graph illustrating each step of the synchronization method of the present disclosure performed at each location.

The graphs show that the synchronization condition determination step S210 is performed in section 1, the synchronization performing step S220 is performed in section 2 or 2′, the synchronization state monitoring step S230 is performed in section 3 or 3′, the synchronization failure diagnosis step S240 is performed in section 4, the synchronization reattempt step S250 is performed in section 5, and the synchronization signal value use permission step S260 is performed in section 6.

As shown in the graphs, when a condition for synchronization is satisfied in the synchronization condition determination step S210, the synchronization performing step S220 starts as the next step. By setting a position sensor value at a time point at which synchronization is able to be performed as an initial value, a synchronization signal value begins to be generated. When the motor is driven, a variation of the hall sensor value occurs. Therefore, the synchronization signal value is generated by cumulatively applying the hall sensor variation for each task to the initial value.

That is, in the graphs, the position sensor value at the time point at which synchronization is able to be performed is 25 (count), so this value is used as the initial value and the variation of the hall sensor value for each task is accumulated to generate the synchronization signal value. Herein, the unit “count” of the position sensor value may represent a value obtained by converting the variation of the position sensor value into a count value so as to correspond to the count value of the hall sensor.

Along with the generation of the synchronization signal value, the synchronization state monitoring step S230 is performed in section 3. As shown in the portions marked with circles, when an absolute value of a value obtained by subtracting the variation of the synchronization signal value from the variation of the position sensor value at the monitoring time point is higher than a particular value and is maintained for a predetermined time, the synchronization state is abnormal, and thus the synchronization failure diagnosis step and the synchronization reattempt step are subsequently performed in sections 4 and 5.

In addition, when synchronization is successfully restarted in the synchronization reattempt step, the synchronization performing step S220 is performed again as in section 2′. By setting the position sensor value at the time point at which synchronization is able to be performed as the initial value, a synchronization signal value begins to be generated again. When the motor is driven, the variation of the hall sensor value occurs. Therefore, the synchronization signal value is generated by cumulatively applying the hall sensor variation for each task to the initial value.

In addition, when a failure of the position sensor occurs, the synchronization signal value use permission step is performed to permit use of the synchronization signal value as in section 6, and gear shift control is performed using the synchronization signal value calculated from the hall sensor value, rather than the failed position sensor value.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A synchronization system of an electric shift lever system of a vehicle, the synchronization system comprising:
a shift lever sensor configured to detect a manipulation signal of a shift lever,
an electric motor configured to switch a gear shift stage according to manipulation of the shift lever,
a relative location sensor attached to the electric motor and configured to detect a rotated relative angle;
an absolute location sensor configured to detect an absolute location of the electric motor; and
a controller configured to receive signals generated from the shift lever sensor, the relative location sensor, and the absolute location sensor, and control the electric motor so that the gear shift stage according to manipulation of the shift lever is switched based on the received signals,
wherein the controller is configured to synchronize the absolute location sensor with the relative location sensor.

2. The synchronization system of claim 1, wherein the controller is configured to monitor a synchronization state, and perform gear shift control by using a synchronization signal value of the relative location sensor when a failure of the absolute location sensor occurs.

3. The synchronization system of claim 1, wherein the relative location sensor is a hall sensor.

4. The synchronization system of claim 1, wherein the absolute location sensor is a position sensor.

5. The synchronization system of claim 1, wherein the shift lever sensor detects the manipulation signal when a vehicle driving mode is shifted.

6. The synchronization system of claim 5, wherein the vehicle driving mode is configured to be shifted by a driver of the vehicle.

7. The synchronization system of claim 1, wherein the controller comprises a motor driving determination part, a synchronization sequence controller, and a sensor failure diagnosis part,
the synchronization sequence controller comprises a synchronization condition determination part, a synchronization performing part, a synchronization state monitoring part, and a synchronization signal value use permission part, and
the sensor failure diagnosis part comprises an absolute location sensor failure diagnosis part and a relative location sensor failure diagnosis part.

8. The synchronization system of claim 7, wherein the synchronization condition determination part is configured to receive information on whether the absolute location sensor and the relative location sensor are normal and on a motor driving state from the sensor failure diagnosis part and the motor driving determination part, and determine whether a condition for generating the synchronization signal value is satisfied,
the synchronization performing part is configured to set, as an initial value, a absolute location sensor value at a time point at which the synchronization signal value is able to be generated, and generate the synchronization signal value by cumulatively applying a relative location sensor variation to the initial value,
the synchronization state monitoring part is configured to continuously monitor whether the absolute location sensor value and the synchronization signal value are synchronized, and
the synchronization signal value use permission part is configured to, when it is determined that the synchronization state is normal and the failure of the absolute location sensor occurs, permit use of the synchronization signal value.

9. The synchronization system of claim 7, wherein the synchronization sequence controller further comprises a synchronization failure diagnosis part and a synchronization reattempt part.

10. The synchronization system of claim 9, wherein the synchronization failure diagnosis part is configured to determine a synchronization error when synchronization monitoring abnormality is detected, and
the synchronization reattempt part is configured to determine whether synchronization reattempt is possible and count up the number of reattempts.

11. The synchronization system of claim 7, wherein the absolute location sensor failure diagnosis part is configured to diagnose a short to ground when an absolute location sensor value is 0%, diagnose a short to battery when the absolute location sensor value is 100%, diagnose an out of range when a value outside a preset normal range is shown, or diagnose a jump error when a change in a value within a diagnosis execution period is detected to be abnormal.

12. The synchronization system of claim 7, wherein the relative location sensor failure diagnosis part is configured to determine whether a failure occurs based on a relative location pattern generated by a plurality of the relative location sensors, and determine that the relative location pattern is an invalid pattern and diagnose a failure of the relative location sensor when the relative location pattern is not shown in a predetermined order according to clockwise or counterclockwise rotation and the predetermined order is violated or when the invalid pattern is detected.

13. A vehicle comprising the synchronization system of claim 1.

14. A synchronization method of an electric shift lever system, the synchronization method comprising:
a synchronization condition determination step of determining whether a condition for synchronization is satisfied, based on information on whether the absolute location sensor and the relative location sensor are normal and a motor driving state;
a synchronization performing step of setting, as an initial value, an absolute location sensor value at a time point at which synchronization is able to be performed, and generating a synchronization signal value by cumulatively applying a relative location sensor variation to the initial value;
a synchronization state monitoring step of monitoring whether the absolute location sensor value and the synchronization signal value are synchronized; and
a synchronization signal value use permission step of permitting use of the synchronization signal value when a synchronization state is normal in the synchronization state monitoring step and a failure of the absolute location sensor is detected.

15. The synchronization method of claim 14, wherein the relative location sensor is a hall sensor.

16. The synchronization method of claim 14, wherein the absolute location sensor is a position sensor.

17. The synchronization method of claim 14, wherein in the synchronization state monitoring step, when an absolute value of a value obtained by subtracting a variation of the synchronization signal value from a variation of the absolute location sensor value at a monitoring time point is higher than a particular value and is maintained for a predetermined time, it is determined that the synchronization state is abnormal.

18. The synchronization method of claim 14, wherein when the synchronization state is abnormal in the synchronization state monitoring step, the synchronization method further comprises a synchronization failure diagnosis step, and a synchronization reattempt step.

19. The synchronization method of claim 18, wherein in the synchronization failure diagnosis step and the synchronization reattempt step, it is determined whether the failure of the absolute location sensor occurs, and when the failure of the absolute location sensor has not occurred, synchronization is reattempted, and when synchronization reattempt is performed a predetermined number of times or more, a synchronization failure is diagnosed.

20. A non-transitory computer readable medium containing program instructions executed by a processor, the computer readable medium comprising:
program instructions that determine whether a condition for synchronization is satisfied, based on information on whether an absolute location sensor and a relative location sensor are normal and a motor driving state;
program instructions that set, as an initial value, an absolute location sensor value at a time point at which synchronization is able to be performed, and generate a synchronization signal value by cumulatively applying a relative location sensor variation to the initial value;
program instructions that monitor whether the absolute location sensor value and the synchronization signal value are synchronized; and
program instructions that permit use of the synchronization signal value when a synchronization state is normal in the synchronization state monitoring step and a failure of the absolute location sensor is detected.
